(19) United States
(12) Patent Application Publication
(10) Pub. No.: US 2008/0040653 A1
(43) Pub. Date: Feb. 14, 2008

(54) System and methods for managing presentation and behavioral use of web display content

(76) Inventor: Christopher Levine, San Francisco, CA (US)

Correspondence Address: GERALD B ROSENBERG;NEW TECH LAW, 260 SHERIDAN AVENUE, SUITE 208, PALO ALTO, CA, 94306-2009, US

(21) Appl. No.: 11/504,259

(22) Filed: Aug. 14, 2006

(51) Int. Cl. G06F 17/00; G06F 17/30; G07G 1/14

(52) U.S. Cl. 715/205; 707/1; 705/14

(57) ABSTRACT

A referral management computer system implements a Web server supporting client browsers that display Web pages having embedded, executable referral content elements executable on user computer systems. Execution of a referral content element observes first predetermined browser actions relative to the embedding Web page and provides first data reflective of the first predetermined browser actions to the referral management computer system independent of user interface actions invoked by a user of the client browser.

The referral content element also observes a second predetermined browser action relative to the embedding Web page provides second data reflective of the second predetermined browser action to said referral management computer system in direct response to the invocation of said second predetermined browser action by said user, wherein the referral content element is further executable to rewrite the embedding Web page to retrieve predetermined content from the referral management computer system for the rendering into the embedding Web page relative to the referral content element, and wherein selection of said predetermined content and timing of retrieval is determined by said referral management computer system.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of the Invention

The present invention is generally related to the automated presentation of informational content on Web pages and, in particular, a system and methods of managing and monitoring the presentation and use of Web display content.

2. Description of the Related Art

The wide and continuing growth in the use of the World Wide Web (WWW or simply, the Web) is due in large part to the relative simplicity of the user interface of client Web browser applications and the wide availability of rich, often graphical, content. This simplicity is, however, largely a user oriented perception. The systems and organizations required to implement, manage, and continually update web sites have grown to become quite complex. Beyond the substantial hardware and software infrastructure required to establish Web sites as operating platforms, the ongoing production and publication of content now typically involves multiple contributors, many commercial in nature. The seamless content of a Web page, as perceived by a user, is frequently the result of a dynamic page generation process that composites content from multiple, often quite different sources. A typical Web page is initially constructed by drawing on multiple data sources in response to a browser originated request. Further substantive contributions may be incorporated even as the page is rendered by the browser. All of this Web site page generation and browser rendering activity is preferably hidden from the user.

As is well known, the Web is a protocol service transported over the Internet, which in turn is constructed as a loosely organized set of networked server systems. These servers execute conventional web server applications that enable client computer systems, executing conventional Web browsers operated by Web users, to request web content from the servers. The network communications between Web browsers and servers is conventionally an implementation of the hypertext transport protocol (HTTP), which characteristically transports standardly encoded content. The most prevalent encoding standard, at least in terms of frequency of use, is the hypertext markup language (HTML). An evolving standard, the most recent formalized specification is known as Extensible HyperText Markup Language (XHTML), first published as a formal HTML 1.0 World Wide Web Consortium (W3C) Recommendation in 2000, revised to version 1.1 in 2001. XHTML 2.0 currently exists as a W3C Working Draft.

XHTML, and its HTML precursor, is a functional markup language that can be used to characterize elements of information, both in terms of appearance and semantics. This structuring of information for appearance, variously denoted as headings, paragraphs, and lists, among other elements, allows browsers to render a reasonably informed and consistent representation of the information. Where established and transmitted as a structured document unit, the corresponding browser-based representation is realized as a Web page. In terms of semantics, text elements can be qualified, for example, as actionable links to other HTML documents or differently encoded content, such as graphical objects. Various action events, including onclick, onmouseover, onkeypress, and onfocus, can be specified for browser interpretation relative to links. For example, onmouseover is characteristically used to affect visual presentation of link text, through modification of the XHTML style of the link element, by the browser. The onclick and onkeypress semantics are characteristically used variously to invoke audible feedback of the actuation of a link and invoke supplementary actions in connection with the submission of form data.

In addition to the semantics directly expressible in XHTML, conventional browsers implement various extension mechanisms, including script interpreters and plugin technologies, to support extended, document defined browser behaviors. JavaScript, an implementation of ECMAScript, standardized by Ecma International (Geneva, Switzerland) in the ECMA-262 specification, and Java™ (Sun Microsystems, Inc., Mountain View, Calif.) are examples. In general, document defined behaviors are used to alter or enhance user interactivity with a specific web page as rendered by a browser. In typical use, JavaScript routines are executed by a browser-based interpreter to perform client-side actions, such as formatting and validation of data and various user interface effects. JavaScript is, however, a fairly rich language and the function of JavaScript routine's can be rather extensive. Java is a comprehensive programming language, enabling Java-based applets to optionally present an independent client-based user interface and perform extensive operations in collecting, transforming, and presenting information.

Various frameworks for structuring the services necessary to composite and generate Web pages have been proposed, developed, and adopted in varying degrees over the years. Different frameworks embody different capabilities, and are chosen accordingly dependent on the particular requirements of specific Web applications. Recently, a Web framework known as AJAX has enjoyed significant adoption based on the ability to construct Web applications that are, from a developmental point of view, reasonably efficient and maintainable, and, from the user point of view, interactive and responsive. AJAX, first described in an online article at www.adaptivepath.com/publications/essays/archives/000385.php, is a coined term generally read as Asynchronous JavaScript and XML.

The principal feature provided by AJAX is support for in-page data structures and components, such as buttons and forms, that can be refreshed asynchronously and specifically without requiring a complete reloading of the Web page. Conventionally, to present a Web page with significantly altered content would require the browser to issue a request to retrieve a new Web page composited with the updated informational content. AJAX supports implementation of small JavaScript routines that, in response to browser events, will exchange small amounts of data directly with a Web or other backend data server. This asynchronous data retrieval is performed using the XMLHttpRequest element defined by the XHTML standard. Conventional browsers provide an API allowing JavaScript routines access to issue XMLHttpRequests and receive the returned data. An XMLHttpRequest call will establish an independent connection channel between the client-side browser relative to the Web page and a remote Web server. The returned data, typically encoded using a conventional extensible markup language (XML) representation, is typically returned from a server-side back-end database. The retrieved data, as decoded, is then locally composited with the existing Web page and rendered by the browser, resulting in a fast, discrete, interactively non-disruptive presentation of the updated information.

Beyond the complexities of presenting Web page content in a clear and consistent manner for simple interactive use, substantial complexities exist in the relationships that define the information presented on non-trivial Web pages. Although Web sites are uniformly presented to users as simple, consistently patterned collections of Web pages delimited by a shared domain name, many and certainly most commercial Web sites are the product of a complex set of referral relationships. Much of the content presented on these Web pages for user consumption is dynamically determined by the then existing referral relationships. In most cases these referral relationships resolve rather directly to economic interests typically realized by the placement of advertisements.

Conventionally, referral programs are established by content oriented Web site operators to accept advertising content from affiliate Web sites. Content oriented Web sites may take many forms, including for example large-scale news organization Web sites to special interest Blogs, or weblogs, to aggregator sites that collect and present contributed and commercially generated content, often in the form of articles, columns, newsletters, commentary and the like. Advertising content is typically presented as clickable, affiliate produced text and graphics-based links. Compensation is typically based on some combination of page impressions, representing the number of times an advertisement is presented for viewing by users and the number of so-called clickthroughs, where a user affirmatively clicks or otherwise actuates the Web page link represented by an advertisement. Clickthroughs are more highly valued as they represent an actual interest by a user in the product or service being advertised and, therefore, more likely to result in the completion of a subsequent commercial transaction. The advertising charge for clickthroughs is therefore considerably higher for clickthroughs.

As may be well appreciated, a significant industry has developed to take advantage of the referral opportunities presented by popular Web pages to guide user exposure, generally referred to simply as Web page traffic, to other, typically commercially oriented Web sites. Elements of this industry are focused on the preparation of advertising banners and related display content, development of product and service advertising campaign strategies and the selection of content Web sites for inclusion in specific campaigns. Other elements are focused on providing the systems and management services necessary to provide real-time accounting of the page impressions and clickthroughs, as well as perform aggregate and statistical analysis of the user traffic patterns and the effectiveness of advertising campaigns in relation to different products and the content Web sites selected for use in the campaign.

A key aspect affecting the economics of advertising campaigns is the nature of the users viewing content pages included in a campaign and the frequency of views and clickthroughs. While many factors may be considered, search engine ranking of the content Web page is a principal consideration. Search engines, such as Goggle™ and Yahoo®, have and will likely continue to be a primary tool of users for finding and thus guiding traffic to different content Web sites. Other organizations, particularly including those directly employed by advertisers to track and maintain accountings of actual page views and clickthroughs, can also develop page rankings.

The search engines typically use page rankings as a statistical basis for organizing search results to better reflect the most likely relevant and quality Web pages responsive to user queries. Advertisement monitoring companies directly accumulate usage data principally to support cost accounting. For both, the specifics of the accounting analysis and page ranking algorithms used to score Web pages are proprietary and, particularly in the case of the search engines, include potentially subjective components. Still, the general nature of these algorithms is to rank content Web pages higher based on whatever statistically significant factors can be ascertained from the available data. These factors may include the frequency of clickthrough from the search results page, the frequency of reference by other content pages further qualified by the determined ranking of those content pages, the currency, that is the substantive update frequency, of the page content, and potentially various semantic assessments of the nature and quality of the page content.

Page ranking scores are typically used as a relative gauge of the likely value of including a given content Web page within an advertising campaign and, moreover, some indication of the likely economic value that may result from inclusion. An accurate determination of relative page rankings is therefore important to the development of effective advertising campaigns. Accuracy is also highly important to the advertiser, as the beneficial cost of an advertising campaign directly correlates to the conversion of views and clickthroughs to economic purchases.

Unfortunately, the accuracy of page rankings is distorted by two principal factors. The first factor is largely a product of the underlying complexity of Web site systems and the dynamic generation of the uniform resource locators (URLs) used as Web page addresses. As is known, a simple URL encodes the domain and page identifier presented by a client browser to retrieve a given Web page. Given the geographic scope of the Web, performance requirements, and for other reasons, multiple different URLs can functionally code for the same essentially static Web page. Where the page is dynamically generated, which is conventionally the predominant circumstance for complex Web sites, the URLs provided to the client browser pending user selection are themselves dynamic references. That is, the dynamic URLs typically encode some transaction or session identifier that is intended to provide a temporally unique reference to the Web site server systems. To the search engines and other page ranking organizations, these different URLs cannot be reliably resolved as actually referencing the some Web page. Accordingly, the ranking of the underlying page is necessarily-diminished by an unquantifiable measure.

The second factor affecting page ranking is known generally as click-fraud. Individuals, directly or by using automated systems, perpetrate click-fraud by functionally emulating in large number the performance of page views and clickthroughs on advertisements by ordinary users. These views and clickthroughs are accounted and charged to the advertisers, resulting, at a minimum, in meaningless loading of the content Web site and advertiser servers and an artificial inflation of the content page rankings. More immediately, however, the advertiser suffers a direct economic loss that is frequently substantial. Although the cost-per-click chargeable to the advertiser for page views and clickthroughs is typically a fractional cost, the cumulative cost over a period of days or weeks from a concerted click-fraud attack can far exceed the expected profitability if not outright costs of an advertising campaign.

Consequently, there is a clear need for a better system of supporting affiliate relationships that is more transparent to the users and that improves resistance to, if not precludes, the occurrence of click-fraud.

### SUMMARY OF THE INVENTION

Thus, a general purpose of the present invention is to provide an improved system and methods of supporting affiliate relationships that is transparent to users and provides a substantial capability to detect and prevent click-fraud.

This is achieved in the present invention by providing a referral management computer system that implements a Web server supporting client browsers that display Web pages having embedded, executable referral content elements executable on user computer systems. Execution of a referral content element observes first predetermined browser actions relative to the embedding Web page and provides first data reflective of the first predetermined browser actions to the referral management computer system independent of user interface actions invoked by a user of the client browser.

The referral content element also observes a second predetermined browser action relative to the embedding Web page provides second data reflective of the second predetermined browser action to said referral management computer system in direct response to the invocation of said second predetermined browser action by said user, wherein the referral content element is further executable to rewrite the embedding Web page to retrieve predetermined content from the referral management computer system for the rendering into the embedding Web page relative to the referral content element, and wherein selection of said predetermined content and timing of retrieval is determined by said referral management computer system.

An advantage of the present invention is that behavior of the affiliate reference system can be controlled to precisely manage the perceived referral relationship for each instance of referral content. In typical implementation, referral target links visible to users and search engine spiders as well present actual target URLs. An independent affiliate link is maintained and used by the affiliate reference system with respect to each referral content element.

Another advantage of the present invention is that the target link ultimately invoked from a referral content element can be selectively resolved and applied dynamically by the affiliate reference system. The selection can be preformed local to the referral content element or remotely by the affiliate reference system itself.

A further advantage of the present invention is that the referral content element can be actively utilized to monitor for Web page related activity that, in turn, can be examined and used by the affiliate reference system to detect and block instances of click-fraud and other undesirable user and pseudo-user activity. The information actively collected by the referral content element can be also used in analysis of the business relevant performance of the presented content. The collected data, including duration of view, mouseovers, location of clicks and other behaviors observable by the referral content element, as well as user profile data, enables a uniquely detailed analysis of how particular content, including in relation to other content simultaneously presented on the Web page is perceived and responded to by users.

Still another advantage of the present invention is that the referral content element enables a dynamic revision and contextually appropriate progression of the content presented by the referral content element. User profile information as well as immediately observed user behaviors can be used by the present invention to determine the selection and sequence of informational content, including advertisements, that are progressively presented to a user. Each referral content element can accumulate user behaviors, which can be used independently or collectively by the affiliate referral system in choosing subsequent content to be presented by the separate referral content elements.

Yet another advantage of the present invention is that the nature and structure of affiliate referral systems constructed in accordance with the present invention are relatively easy to establish and maintain in comparison to existing affiliate Web site systems. Referral content elements are packaged and distributed in a manner compatible with existing industry practices for incorporation of referral codes into Web pages as composited by conventional content provider Web site operators. Each referral content element, as initially distributed to content provider Web site operators, is a functionally minimal code statement sufficient to identify and request loading of a run-time referral content element. Browser-based execution of the referral content element efficiently results in local composite rendering of the referral element content into the Web page transparently with respect to both the content provider Web site and user.

### BRIEF DESCRIPTION OF THE DRAWINGS

FIG. 1 is a simplified block diagram illustrating a preferred environment for use of the present invention.

FIG. 2A is an illustration of a representative Web page presenting graphical and textual creative blocks and content textual blocks as may be utilized in connection with a preferred embodiment of the present invention.

FIG. 2B is an illustration of a preferred tiered implementation of the presentation and control elements utilized in a preferred embodiment of the present invention to support operation of a creative advertising block.

FIG. 3 is a block diagram of a system implementation of a preferred embodiment of the present invention.

FIG. 4 provides a flow diagram illustrating the predominant information and action flow in the use of preferred embodiments of the present invention.

FIG. 5 is a block diagram illustrating the associated structure and operation of an advertisement management Web server, constructed in accordance with the present invention, and a client Web browser operating to display an affiliate Web page.

FIG. 6 is a flow diagram illustrating the process operation of an advertisement management Web server, constructed in accordance with the present invention, and a client browser.

FIG. 7 is a block diagram illustrating the associated structure and operation of an advertisement management Web server, constructed in accordance with the present invention, and a client Web browser interoperating to manage the request selection of a target Web page.

FIG. 8 is a flow diagram illustrating the process operation of an advertisement management Web server providing for a dynamically determined alternate target address as implemented in accordance with the present invention.

### DETAILED DESCRIPTION OF THE INVENTION

The present invention addresses the need to efficiently provide and manage content provided through affiliates and accurately account for referrals resulting from the presentation of the content. While not so limited, the predominant use of the present invention is expected to involve placement of advertisements on affiliate Web site produced Web pages in execution of an advertising campaign. As used in the following description, an affiliate is generally defined as a Web site owner, operator or similar individual or entity who has a relationship with a merchant, including vendors, providers, and similar individuals and entities, to promote a product or service, or otherwise distribute information, offered by the merchant. The typical relationship is commercial in nature, with the affiliate earning a commission, under varying circumstances, in connection with the presentation of the advertisement on Web pages sourced by or on behalf of the affiliate.

Affiliate relations are conventionally defined in the context of advertising campaigns. A merchant, or advertising Web site owner, operator or similar individual or entity acting on behalf of a merchant, contracts with an affiliate to incorporate advertising units into the Web pages served by the affiliate. Each advertising unit is typically defined in terms of the size, frequency, associated Web page content, and other presentation style related features under which the affiliate will distribute the advertising unit. Distribution occurs by the affiliate directly or indirectly incorporating a so-called creative, which is typically a graphical image, text block or combination of text and graphics, into the Web pages served by the affiliate. The appearance of the creative is determined by the merchant and may range broadly from commercial to public service messages. The appearance of the creative may also be produced by execution of an applet or program within or under the control of the client browser application.

In conventional implementation, the merchant provided advertising unit includes a short HTML code block pre-configured for incorporation into affiliate Web pages. This HTML code block conventionally includes an image reference that will cause retrieval of the creative from a typically dedicated advertising Web server when the Web page is evaluated and rendered by a client browser. The HTML code block also conventionally includes a link target reference to the advertising management Web server or other designated link invocation auditing server that will authoritatively count user invoked clicks on the advertising graphic, resulting in referral actions. The auditing Web server will typically return an HTTP redirection message to provide the client browser with a new target address to use in requesting a next Web page.

Referring to FIG. 1, a Web environment 10 suitable for use in the implementation of the present invention is shown. For convenience in the following description of the preferred embodiments of the present invention, like reference numerals are used to designate like parts depicted in one ore more of the figures. A representative client browser 12, implemented as a conventional application executed on a client computer system, provides for the display of Web pages. An address bar field 14 allows entry of a uniform resource locator (URL) that defines the address of a Web page to be requested by operation of the client browser 12. Invocation by a user operating the client browser 12 results in transmission of a corresponding HTTP protocol request 16 to a target Web page server 18. The protocol response 20 returns the URL identified Web page 22.

Hyperlink elements 24 are typically embedded within the text of the Web page 22. These elements 24 are characteristically coded as anchor HTML statements with a target URL attribute, optionally associated with an image statement or link text. When a user clicks on a hyperlink element 24, the client browser 12 utilizes the target URL as the request address for a new Web page to be retrieved and presented in the client browser 12. A text representation of the target URL is also typically displayed in a status bar 26 whenever the cursor hovers over a hyperlink element 24. Conventional search engine spiders recognize and follow the target URLs in connection with the indexing and page ranking of Web pages. While an anchor statement may include or encode additional attributes that may also include URLs, none are shown on the status bar 26 or conventionally considered by search engine spiders purposes of indexing and, in particular, page ranking.

Where referral auditing is employed, the merchant provided target URL characteristically references a merchant and affiliated authorized auditing server 30. The target URL also encodes an identifier sufficient for the auditing server 30 to issue an HTTP redirection message 32 containing a new target URL to the client browser 12. This replacement target URL is then used as a request 34 issued to a merchant Web server 36. A Web page 38, responsive to the context of the invoked hyperlink element 24, is then returned 40 to the client browser 12 for display to the user.

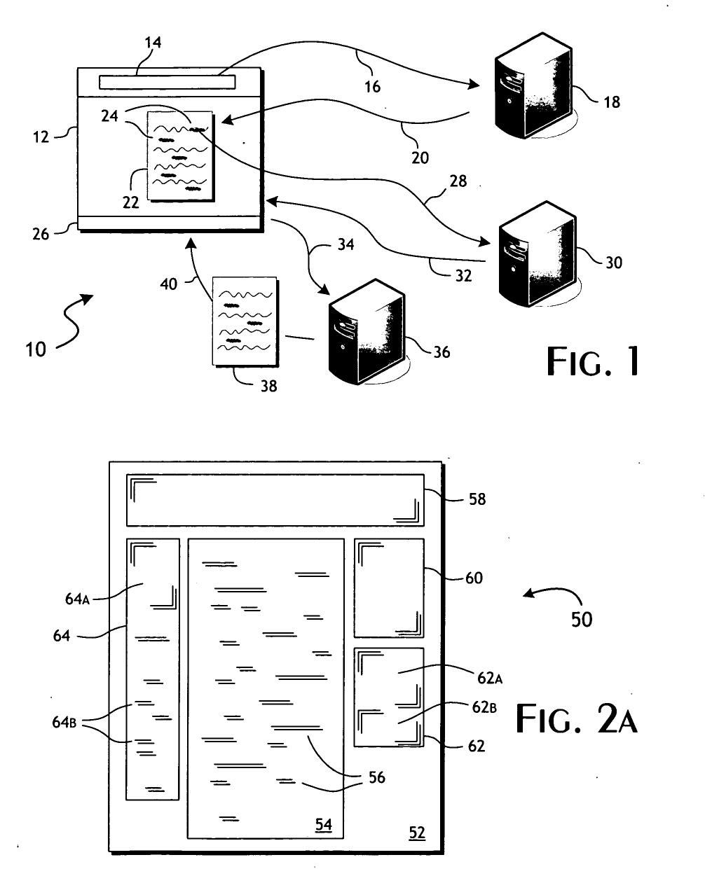

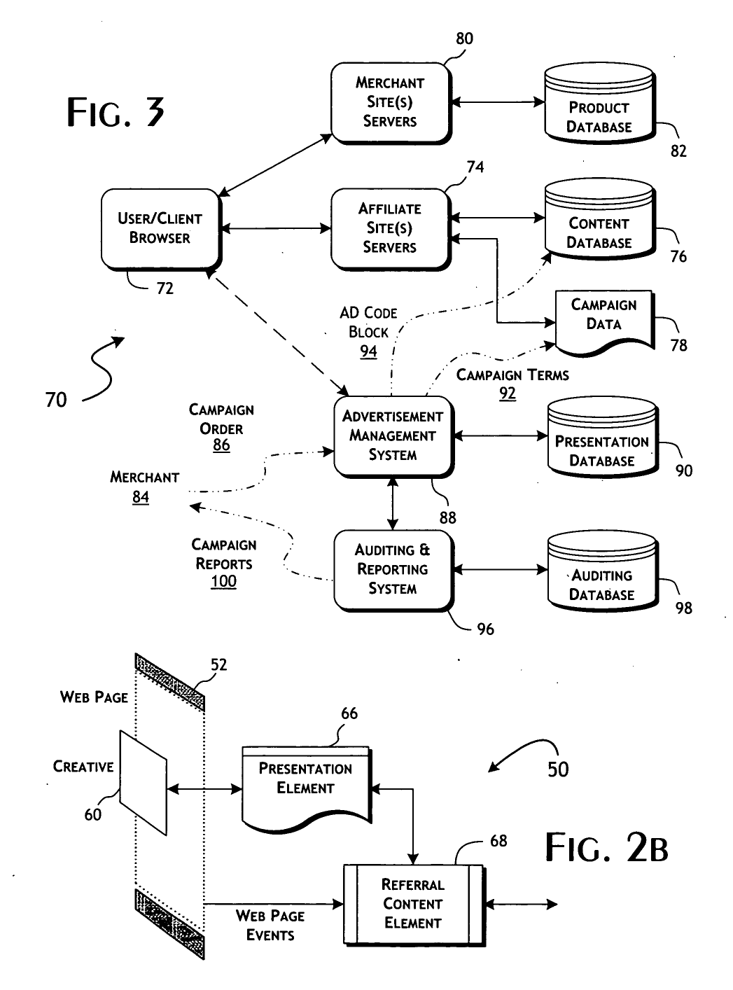

FIG. 2A provides a representation 50 of a Web page 52 as potentially rendered using an embodiment of the present invention. The general presentation of the Web page 52 is highly configurable in practice. The representation 50, for purposes of discussion, is configured with a center textual content column 54, having conventional embedded link text hyperlink elements 56, a top banner creative 56, and various side creatives 58, 60, 62, 64. As generally indicated, the banner 56 and side 58 creatives represent single invokeable presentation elements, while the side advertisement 62 includes multiple 62A, 62B invokeable presentation elements, implemented as adjoining graphics or distinguishable regions of a single graphic creative. The side creative 64, as indicated, includes a combination of graphical 64A and text 64B presentation elements that are separately invokeable.

The relationship between creatives and presentation elements is further shown in FIG. 2B. As implemented in the preferred embodiments of the present invention, each distinct creative, such as creative 60, is positioned and managed within a Web page 52 by a presentation element 66. A presentation element 66 contains the target URL, style definitions, and event controls used to define the presentation of the creative and, in part, operation of the client browser when the presentation element 66 is functionally invoked by a user action, typically a mouse click or key press, on the creative. The presentation element 66 is incorporated, directly or by reference, into the HTML of the Web page.

Presentation elements 66, in accordance with the present invention, are replaceable or modifiable by a referral content element 68, preferably implemented as an applet or program that executes within or in conjunction with the client browser 12. For the preferred embodiments of the present invention, the referral content element 68 is implemented as a JavaScript program. Functionally, the referral content element 68 executes to monitor Web page events and invocation of the presentation element 66. While the preferred embodiments of the present invention implement separate instances of presentation elements and referral content elements 68, the function of these elements, in alternate embodiments, can be variously combined in support of single creatives or implemented as singletons that cooperatively support multiple creatives in a single Web page.

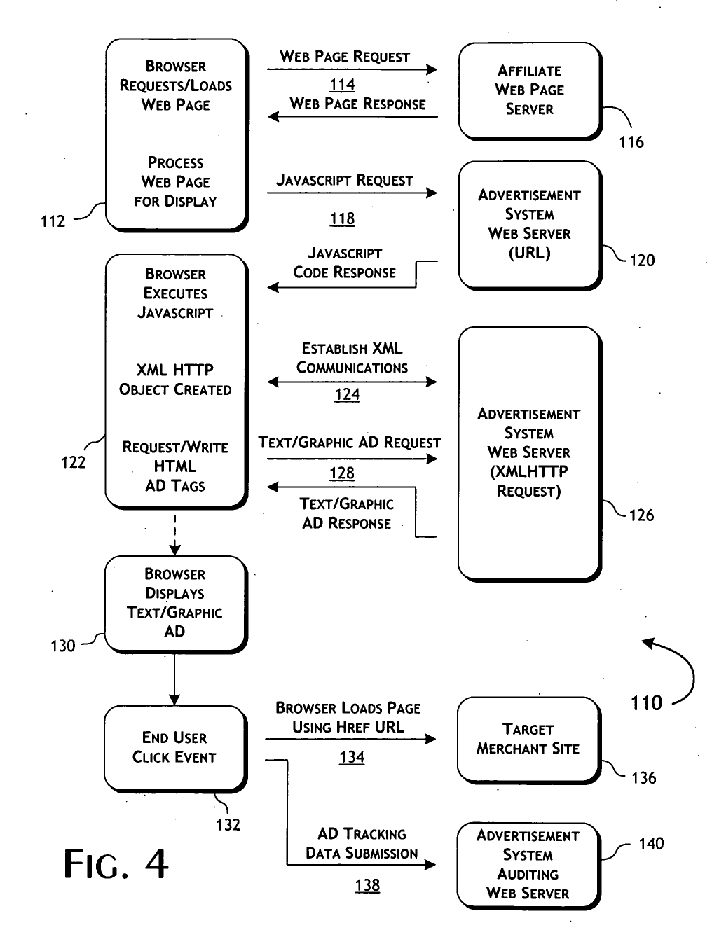

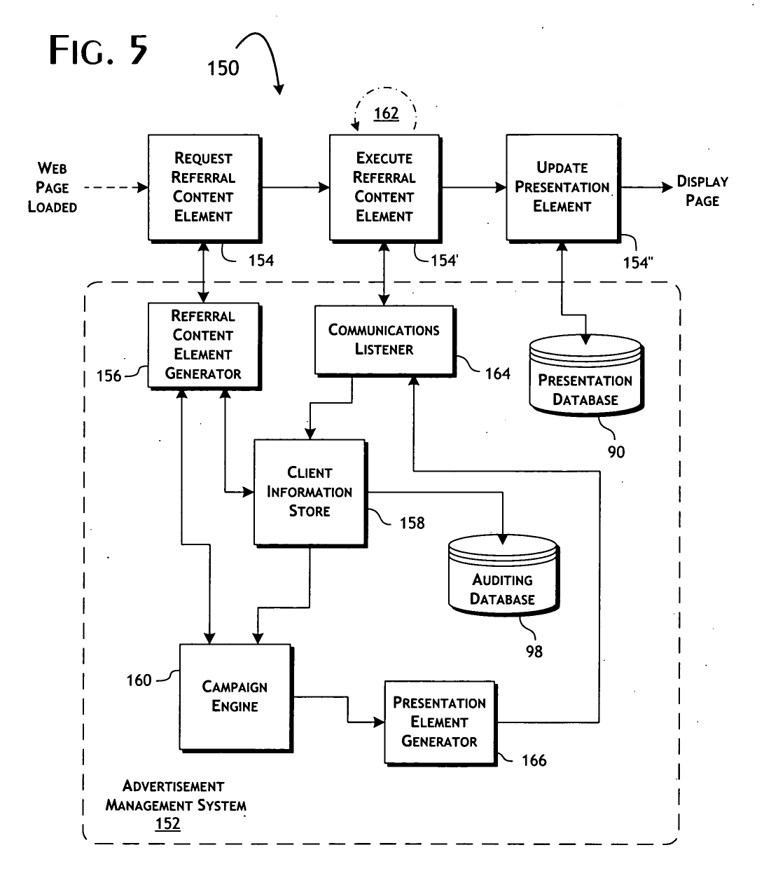

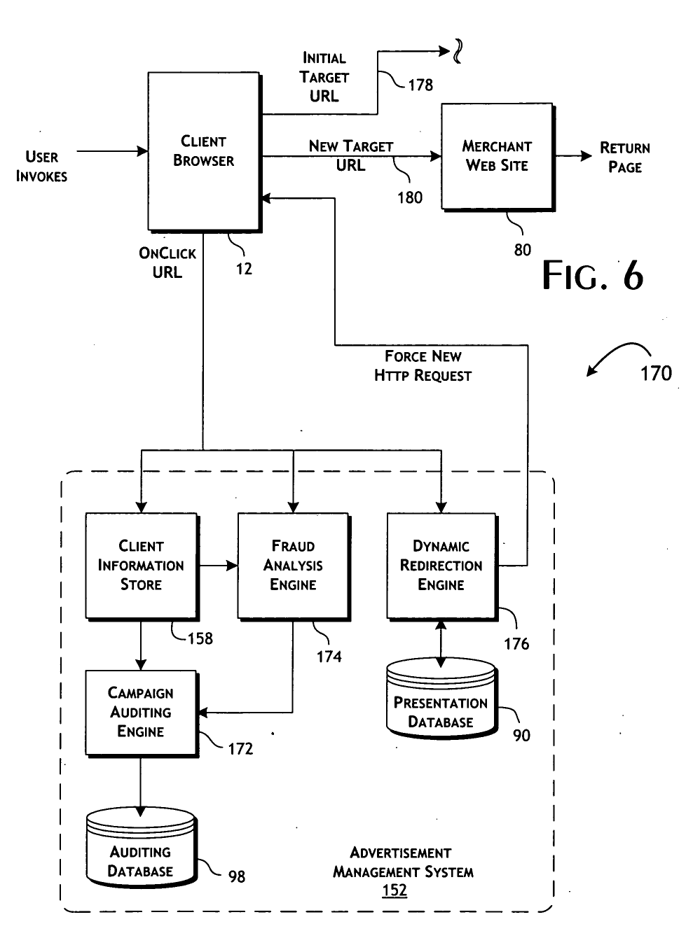

A preferred system architecture 70 implementing the present invention is shown in FIG. 3. A client computer system 72, supporting user operation of a client browser 12, interoperates over a communications network, such as the Internet, with any number of typically content oriented affiliate Web site servers 74. Various content databases 76 are referenced by the affiliate Web site servers 74 in typically dynamic generation of Web pages responsive to specific URL requests received from client browsers 12. In composing these Web pages, the affiliate Web site servers 74 reference affiliate specific campaign data 78 that defines the advertisement units that are to be composited with data from the content databases 76. The campaign data 78 contains the details of the advertisement units accepted by affiliates, including the frequency, duration, page relative location, content association, and other controls and restrictions on the presentation of creatives for particular merchants and advertising campaigns. Thus, the campaign data 78, as evaluated by the affiliate Web site servers 74, allows the affiliates flexibility in preforming advertisement insertions for concurrently running and overlapping advertising campaigns of typically multiple merchants.

In accordance with the preferred embodiments of the present invention, the target URL defined by advertisement presentation elements 66 for the creatives, as visible to users of affiliate Web pages, can be and preferably will always appear to directly reference a merchant Web page. Certain non-terminal user actions in a client browser 12, including placing keyboard focus on and mouse pointer hovering over the creative associated with a presentation element 66, as implemented in a preferred embodiment of the present invention, will display the corresponding target URL, typically in the status bar 26. Displaying a URL that directly references a merchant site server 76 is preferably consistent with use expectations. That is, given a URL represented in a generic uniform resource identifier (URI) form:
scheme://host/path?query#fragment
   the host and path portions of the target URL will refer to a merchant domain and domain local Web page address. A terminal invoking user action, such as by clicking or otherwise invoking any of the presentation elements 66 managed by the present invention, will appear to a user to immediately request the Web page identified by the target URL. Further, the present invention actually allows the target URL to be actually used to request the next Web page that will be presented in a client browser 12 to the user while still fully supporting auditing of terminal invoking user actions. The content of the target URL identified Web page is, in turn, determined by the referenced merchant site server 80 based on data retrieved from various content and product databases 82.

To establish campaign data 78 for a particular merchant 84, a campaign order 86 is placed with an advertising management server system 88. The campaign order 86 preferably identifies the advertisement insertion options, a selection of affiliate site servers 74 to include in the campaign, and the creative or other content that is to be managed by the presentation elements 66 and ultimately presented to users through the client browsers 12. This information is nominally recorded in a presentation content database 90. Advertisement units are then provided to the selected affiliates site servers 74, subject to new or existing affiliate relationships, to define campaign terms 92 for incorporation into appropriate instances of campaign data 78.

The advertisement units further provide advertising code blocks 94 to the affiliates for incorporation into affiliate Web pages dependent on affiliate evaluation of the corresponding campaign data 78. Preferably, advertising code blocks 94 contains a URL reference to the advertisement management system 88 and further encode a campaign identifier used to reference the terms of the campaign order 86 as stored in the presentation database 90. In the preferred embodiments of the present invention, an advertising code block 94 is implemented as a short, inline JavaScript routine that, upon execution in a client browser 12, will fetch a referral content element 68 from the advertisement management system 88 identified by the campaign identifier. The advertisement management system 88 preferably receives the campaign identifier encoded as a query or fragment part of the URL reference to the advertisement management system 88 or otherwise as a value parameter transmitted upon execution of the inline JavaScript routine. The referral content element 68 returned will be selected or dynamically constructed by the advertisement management system 88 based on the campaign identifier.

In accordance with the present invention, the operation of the advertisement management server 88 relative to client browsers 12 is hidden from or transparent to the users of the client computer system 72. The advertising code blocks 94 embedded in a Web page execute on loading of the Web page to fetch respective referral content elements 68 that, upon execution in the client browser 12, retrieve and install a corresponding presentation element 66. The presentation elements 66, in turn, direct the retrieval and rendering of the creatives visible to the user. The user, however, only perceives the visible presentation of the creative. When a creative is clicked or otherwise invoked, the referral content element 68 that backs the invoked presentation element 66 interoperates, preferably asynchronously, with the advertisement management system 88. Notice of the referral request, including relevant data respecting the presentation element 66, client browser 12, and associated user behaviors is provided to the advertisement management system 88. This information is further proceed by auditing and reporting server systems 96. Referral requests are accounted utilizing as much detail as is provided by the referral content elements 68, allowing auditing of apparent referrals and discounting of referrals characterized by the auditing system 96 as presumptively fraudulent. Campaign reports 100, summarizing the referral accounting information can be subsequently provided to the merchant 84. Since the interoperation between the client browser 12 and advertisement management system 88 is asynchronous at least for the preferred embodiments of the present invention, there is no added user apparent latency in loading of the merchant Web page associated with the invoked creative.

An operational flow 110 of information between a client browser, affiliate Web site, merchant Web site, and advertisement management system, as implemented by a preferred embodiment of the present invention, is shown in FIG. 4. In a first stage of operation, a client browser 112 will request 114 a Web page from an affiliate Web page server 116. In conventional manner, the Web page is retrieved and evaluated for presentation to the user. When the browser encounters an advertisement code block 94, the inline JavaScript code is executed to request 118 loading of a referral content element 68 that will host a corresponding presentation element 66 for presentation of a creative visible to a user of the client browser. The referral content element 68 is preferably retrieved from the advertisement management system 120 using a URI-based request.

Once loaded, the referral content element 68 is evaluated 122 by the client browser 112. In the preferred embodiments of the present invention, the referral content element 68 is also a JavaScript program constructed to run as a background program within the context of the client browser 112. In execution, the referral content element 68 creates an XMLHTTPRequest object to support an asynchronous, background communications channel 124 with the advertisement management system 126. In execution, the referral content element 68 initially and, preferably, at intervals, provides the advertisement management system 126 with information about the client browser and, inferentially, the user of the client browser. The referral content element 68 also initially requests 128 an identification of a presentation element 66 to be hosted by the referral content element 68. The referral content element 68 typically receives this identification as a text value that is then written directly or by reference into the HTML text of the Web page as some combination of a URL-based argument of an HTML image statement and presentation link text. The client browser then retrieves the image statement identified creative and renders the Web page for display 130. At intervals, preferably in connection with the referral content element 68 providing client browser and user information, the advertisement server system 126 can provide a new identification of a creative or, alternately, entire presentation element 66 to be incorporated into the Web page rendered by the client browser. In preferred implementation, the image reference to the creative, associated target URL, and other parts of the presentation element 66 dependent on the identity of the creative are re-written by the referral content element 68. The client browser will then, as needed, automatically retrieve the referenced creative and re-render the Web page visible to the user.

In response to a user invoking 132 the presentation element, the target URL is automatically used by the client browser to request 134 the corresponding Web page from the target URL identified merchant Web site server 136. Concurrently, the referral content element utilizes the communications channel 124 to report 138 the referral to the merchant site to the advertisement server system for auditing 140. Preferably, the on Click event is recognized to initiate the identification of the referral to the advertisement management system 138.

A preferred functional architecture 150 of an advertisement management server system 152, constructed in accordance with the present invention, is shown in FIG. 5. Following from a client browser 12 loading a Web page containing an advertising code block 94, two stages of operation are preferably implemented. The first stage is preferably limited to identifying and retrieving an appropriate referral content element 68 from the advertisement management system 152. The second, more extensive stage, is implemented with the execution of the referral content element 68 to establish and operate an asynchronous XMLHTTPRequest-based communications to both provide user behavior related information to the advertisement management system 152 and obtain user behavior dependent updates for implementation into the presentation element 66 hosted by the referral content element 68. This separation into two stages is intended to simplify and substantially genericize the advertisement code block 94 that is distributed to affiliates. Single stage operation, by distribution of referral content elements 68 directly, or multiple stage operation, by further subdividing the functions of the referral content element 68, are within the scope of the present invention.

In the referred first stage 154, the JavaScript routine implemented by the advertising code block 94 issues an HTTP request to the advertising management system 152 using a URL embedded in the advertising code block 94. Preferably, the embedded URL further encodes a campaign identifier generated and incorporated into the embedded URL prior to distribution to the affiliate Web server systems. Alternately, a campaign identifier can be transmitted in one of a series of transactions with the advertisement management system 152 driven by execution of the advertising code block 94. The campaign identifier is preferably sufficient to enable the advertising management system 152 to identify the terms of a particular campaign order 86.

The HTTP request issued to advertisement management system 152 further transmits a standard set of browser related information. If present, a cookie stored by the client browser specific to the domain identified by the embedded URL is also transmitted. For the preferred embodiments of the present invention, a cookie is used to store a client computer system identifier used to inferentially identify a user. While some profile related data may be stored in the cookie, the principal content is preferably a secure identifier that can be used by the advertising management system 152 to recall user profile data stored by the advertising management system 152.

The basic hardware and systems related configuration of the advertising management system 152 are substantially conventional and typically implemented as a functionally delegated and load sharing set of computer servers that collectively function as the advertising management system 152. A conventional Web server application is sufficient to support the preferred communications with the client browsers 12. Alternately, other Internet protocols and Web services could be utilized to support communications during one or all of the different stages. For the preferred embodiments of the present invention, the first communications stage transmits the embedded URL request, host and path associated cookie, if any, and a standard collection of browser derived information to the advertising management system 152 as part of a conventional HTTP request transaction. This request is passed to a referral content element generator 156.

For the preferred embodiments of the present invention, referral content elements 68 are JavaScript programs generated with, as between referral content elements 68, a set of commonly implemented functions operative subject to parameters selected and set during element generation. These functions include:
1) creation of a local XMLHTTPRequest object,
2) establishment of an asynchronous communications with the advertising management system 152 using the XMLHTMLRequest object with any of a generation parameter defined set of primary and optional backup URLs,
3) collection and forwarding to the advertising management system 152 of client computer system information accessible through the client browser, including the forwarding and restoring of a browser cookie,
4) collecting event data representing client browser events, including, but not limited to, on Click, on DblClick, on DragDrop, on Focus, on KeyPress, on Load, on MouseDown, on MouseMove, on MouseOut, on MouseOver, on Resize, on Select, and on Submit, and variously recording time of occurrence, duration, and cursor location related to the events and event series,
5) forwarding the event data to the advertising management system 152 using the XMLHTMLRequest object at generation parameter defined intervals
6) receiving presentation element configuration data from the advertising management system 152 via the XMLHTMLRequest object, and
7) composing an HTML statement incorporating new or updated presentation element configuration data and re-writing the current Web page to include this information.

The generation parameters are preferably resolved by the advertisement management server based in part on the profile data identified by the cookie, if any, received from the client browser and the campaign identifier. In a preferred embodiment of the present invention, the cookie identifier is used to retrieve prior recorded client reference information from a persistent client information store 158 maintained by the advertisement management system 152. In particular, the cookie identifier can be used to identify which creatives have already been presented to the user and which have been successful in obtaining referrals. The campaign identifier is similarly passed to a campaign engine 160 to retrieve the applicable terms and related specification data associated with the identified campaign.

In response, the referral content element generator 156 selects the parameter values, including in particular the primary and backup set of URLs to be used to reference the advertisement management server 152 and the iteration rate of providing event data to the advertisement management server 152. Optionally, the content element generator 156 may further identify the set or type of user specific information to be gathered from the client browser 12 and client computer system 72 through execution of the referral content element 68.

Preferably, the advertising management system 152 returns presentation element update data selectively in response to the reports of event data. Thus, the rate of updating the creative viewed by a user is a multiple of the parameter determined interval used to report event data. The generated referral content element is preferably stored by the advertisement management system 152 pending retrieval for execution on the client browser.

Event data, including notice of a terminal event due to the invocation of a corresponding presentation element 66, is provided to an XMLHTTPRequest communications listener 164 during second stage execution of the referral content element 68. The timing of event data delivery is preferably determined by an independently running timer function 162, implemented within referral content element 154′, whose step duration is originally determined by advertising management system 152 in generating the referral content element 154′ with a chosen interval parameter. The client information store 158 receives and persistently stores the event data and accompanying client information as provided by the referral content element 68. This client information is preferably utilized to establish and update a reference profile for distinguishable users. In the preferred embodiments of the present invention, client profiles include browser type, internet protocol (IP) address, domain and other standard browser request provided information, including screen resolution, number of display colors, operating system make and version, browser manufacturer, client platform type, and default language. In addition, information uniquely identifying a client computer system 72, such as a media player or other secured application identifiers where such information can be accessed by the referral content element, is also collected and recorded. The event data is also stored directly or in summarized form.

The collected and stored event data is processed by the campaign engine 160 as a basis for choosing updated presentation element data to be returned to the referral content element 68. Preferably, the event data is analyzed to inferentially identify user behaviors that, in turn, can be used as a selection criteria for the product or service to be presented by the presentation element. For example the success rate of invoking presentation elements for particular classes of products or services can be used in selection among the products or services offered by a particular merchant. Similarly, the duration that a user appears to linger on a type or class of advertisement, as inferred for example from the duration of a mouseOver event, can be weighted as an indication of potential interest of the particular product or service then displayed. Conversely, short durations of a user spent viewing pages with particular advertisements can be weighted as a lack of interest in the particular product or service. Based on the historically inferred interests of a particular user, the campaign engine selects among the available advertisements available from the corresponding merchant to select the next presentation data for update to the referral content element.

A presentation element generator 166 is provided with the selected presentation data. A revised presentation element, or updateable portions thereof, is generated and provided to the referral content element 68. For the preferred embodiments of the present invention, a presentation element 66 will include:
1) style and structure information that defines the presentation of a text or graphical content element,
2) a reference to the underlying referral content element to maintain execution of the referral content element, and
3) a hypertext link statement including
   A) a target URL reference to be used on invocation of the presentation element,
   B) an on Click event reference, activated on invocation of the presentation element, that will provide a message to the referral content element, and
   C) an image statement and/or text to be used as the object of the hypertext link.

Once generated, the presentation element 66 or sufficient information to update the existing presentation element 66, is returned by the generator 166 through the communications listener 164 to the referral content element 68 for incorporation into the current Web page displayed by the client browser. Once incorporated by the referral content element 68, the client browser 12 will render the modification to the Web page 154″, including retrieval of any referenced creative from the presentation database 90 as maintained by the advertisement management system 152. A representative presentation element is provided in Table I.

TABLE I
Presentation Element

```
<style type=“text/css”>
  .srAdTable {
    width: 728px; height: 90px; border-width: 0px;
    font-family: Verdana, sans-serif;
    }
  .srAdImgBox {
    width: 728px; height: 90px; border: 0px;
    background-color: [BackColor];
    }
  .srAdImg { border: 0px; }
</style>
<script type=“text/javascript”
    src=“[HTTP][ClickBaseDomain]/[ReferalElementScript]”>
</script>
<table class=“srAdTable” cellspacing=“0px” cellpadding=“0px”>
<tr><td class=“srAdImgBox”>
    <a target=“[AdLinkTargetWindow]” href=“[ClickURL]”
        onclick=“javascript:srSendRequest(
        ‘[HTTP][ClickBaseDomain]/ad?c=[ClickString]&cMode=1’);”>
    <img class=“srAdImg” src=“[HTTP][CreativeURL]” /></a></td>
</tr>
</table>
```

where the bracketed metadata, substituted with concrete values provided by the referral content element 68 at execution time, are defined as follows:
[BackColor] image box background color
[YourAdBackColor] creative background color
[YourAdTextColor] creative text color
[HTTP] http scheme
[ClickBaseDomain] host and path of the advertisement management system 152
[ReferalElementScript] JavaScript routine implementing the referral content element 68
[AdLinkTargetWindow] reference to window containing the creative
[ClickURL] merchant target URL
[ClickString] creative/campaign identifier
[CreativeURL] host and path to the creative image

Preferred embodiments of the present invention include, as part of the system implementation 170 of the advertisement management system 152 as shown in FIG. 6, further support referral auditing, including fraud detection, and optionally dynamic target URL redirection. Auditing of referrals is achieved by recording the event data forwarded by the referral content element 68 in response to the invocation of a presentation element 66. Preferably, from detection of an on Click event, the corresponding referral content element 68 provides an identification of the presentation element 66 invoked, and a full set of browser related data, to the advertisement management system 152. This event data is received, as before, by the client information store 158 and stored. The event data is further proceed by a campaign auditing engine 172 to associate this referral event with a particular merchant campaign. The resultant auditing data is recorded to the auditing database 98 to support various auditing analysis as well as in producing the campaign progress reports 100.

The referral event data is also preferably provided to a fraud analysis engine 168 to characterize invocation events. Similar to the campaign engine 160, the fraud analysis engine 174 preferably examines the event data to infer behaviors indicative of fraudulent invocations of the presentation element 66. Invocations from the some client browser 12 repeated within very short time frames from the same client computer system 72 are presumed fraudulent. In accordance with the present invention, referral event interval time, if considered alone, is recognized as an imprecise and inadequate criteria. The fraud analysis engine 174, in accordance with the present invention, is preferably capable of considering all events observable through the client browser 12 by the referral content element. This full set of event data is analyzed and utilized to infer and distinguish presumptive fraudulent user behaviors.

In accordance with the present invention, factors potentially indicative of fraudulent behaviors preferably include, but are not limited to, variances in the period of time that a Web page is presented before a presentation element is invoked, whether the presentation element is repeatedly invoked by a mouse click or key pressed action, variance in the time that the cursor is over the presentation element prior to invocation, variance in the presentation element relative location of the cursor when the presentation element is invoked. Characterization of these factors as presumptively fraudulent is preferably established relative to empirical threshold values. Optionally, a statistical analysis engine can be employed to dynamically assess the choice of factors, individually and collectively, utilized in characterization and the threshold values that are used in discriminating presumptive fraudulent referral events. Preferably, the fraud analysis engine reports the determined characterization of the referral event data to the campaign auditing engine 172.

A dynamic redirection engine 176 for target URLs is optionally provided in the advertisement management system 152. Where implemented, the dynamic redirection engine 176 preferably also receives the referral event data produced in response to the invocation of a presentation element. The target URL included as part of the presentation element is automatically used by the client browser 12 to issue a request 178 for the corresponding Web page. This initial target URL preferably references a home or other base Web page identified by the merchant in creating the campaign order 86. This base Web page URL will be visible to search engine spiders and, through common use as the target URL for multiple presentation elements, the corresponding merchant Web page will benefit from cumulative recognition in the generation of page rankings by search engine organizations.

The dynamic redirection engine 176 preferably operates to functionally terminate the initial target URL request 178. Based on the referral event data, the dynamic redirection engine 176, determines from campaign data stored by the presentation database 90, a preferred target URL specific to the presentation element invoked. In accordance with the present invention, this preferred target URL may be a completely new URL, with different host and path parts, or essentially the same URL with added query and fragment parts, or some combination thereof.

The preferred target URL is returned by the dynamic redirection engine 176 through the XMLHTTPRequest connection to the referral content element. In turn, the referral content element directs the client browser 12 to issue a new Web page request 180 using the preferred target URL, effectively terminating the existing request 178. Based on the complete specification of a Web page provided by the preferred target URL, the merchant Web site 80 returns a Web page that is specific to the presentation element invoked by the user and thereby consistent with user expectations.

Thus, a system and methods for functionally enabling sophisticated affiliate relationships that are uniquely beneficial to merchants and similar entities, operates seamlessly to present a consistent and appropriate appearance to users, while providing a substantial capability to effectively detect and prevent click-fraud has been described. While the present invention has been described particularly with reference to merchants and commercial advertising-based transactions, the present invention is fully applicable to the management and auditing of most any hyperlinked Web-based transactions, regardless of the particular nature or content of the creative presented to end users.

In view of the above description of the preferred embodiments of the present invention, many modifications and variations of the disclosed embodiments will be readily appreciated by those of skill in the art. It is therefore to be understood that, within the scope of the appended claims, the invention may be practiced otherwise than as specifically described above.

1. A computer system for managing referral content and actions on Web pages initially sourced by affiliated content Web site servers and presented to users through client browsers, said computer system comprising:
a) a referral management computer system including a Web server program coupleable through a communications network to client browsers executable on user computer systems, wherein said client browsers provide for a plurality of events invoked in response to predetermined user interactions with said client browsers; and
b) a referral content element embedded within a Web page as provided to a client browser, said referral content element being executable by said client browser to monitor a first predetermined action relative to said Web page and to provide first data acquired with respect to said first predetermined action to said referral management computer system independent of actions invoked by a user of said client browser, monitor a second predetermined action relative to said Web page and to provide second data acquired with respect to said second predetermined action to said referral management computer system in direct response to the invocation of said second action by said user, wherein said referral content element is further executable to retrieve predetermined content from said referral management computer system and provide for the rendering of said predetermined content into said Web page with respect to said referral content element, wherein the selection of said predetermined content and timing of retrieval is determined by said referral management computer system.

2. The computer system of claim 1 wherein said client browser is operative to display target URLs respectively associated with user invokeable content elements embedded in said Web page, wherein said referral content element includes a first URL and a second URL, wherein said referral content element is executable to composite said first URL with said predetermined content as an updated user invokeable content element and wherein said second URL is operable as a reference to said referral management computer system.

3. The computer system of claim 2 wherein said referral content element is operative to rewrite said Web page to include said updated user invokeable content element.

4. The computer system of claim 3 wherein said first predetermined action is a mouseover event and said second predetermined action is an onclick event.

5. The computer system of claim 4 wherein said referral content element includes an XML HTTP Request Object and is operative to send said first data to said referral management computer system, wherein said first data includes aggregates of the number and duration of mouseover events.

6. The computer system of claim 5 wherein said first and second data includes profile data determined by said referral content element from said browser with respect to said user, said profile data including an identification of a sequence of said predetermined content presented by said updateable content element.

7. A method of controlling the presentation of selected content on a Web page for viewing by a user of a client browser, said method comprising the steps of:
a) incorporating a referral content element within a Web page as established within a client browser, wherein said Web page is initially retrieved from an affiliate Web site server and wherein said referral content element is executable by said client browser, said referral content element being represented in said Web page by user invokeable content;
b) collecting, by a referral management server, predetermined data observable by said referral content element as executed by said client browser;
c) processing said predetermined data to identify user non-invoking behaviors observed by said referral content element with respect to said user invokeable content;
d) providing, by said referral management server to said referral content element, said user invokeable content, the selection of said user invokeable content provided to said referral content element being responsive to the identification of said user non-invoking behaviors; and
e) rewriting, by said referral content element, said Web page to incorporate said user invokeable content.

8. The method of claim 7 wherein said step of collecting provides for the collection of a first portion of said predetermined data at intervals independent of invocation of said user invokeable content and a second portion of said predetermined data in response to invocation of said user invokeable content.

9. The method of claim 8 wherein said step of processing includes processing said first portions to identify repeated and non-repeated user behaviors precursive to said second portions, wherein closely repeated user behaviors in terms of timing, selection and invoking of said user invokeable content is characterized as automated invocations of said user invokeable content, said method further including the step of recording the numbers of invocations of said user invokeable content characterized as automated and non-automated invocations.

10. The method of claim 8 wherein said step of incorporating includes the steps of:
distributing a referral element loader for incorporation into said Web page pending retrieval from said affiliate Web site server,
retrieving, by said client browser upon evaluation of said referral element loader, said referral content element from said referral management server.

11. The method of claim 10 wherein said step of retrieving further provides said referral management server with predetermined client browser data in a request sent to said referral management server to retrieve said referral content element.

12. The method of claim 11 further comprising the step of selecting, by said referral management server, said referral content element, responsive to said predetermined client browser data.

13. The method of claim 12 wherein said step of collecting provides said first portion at first intervals to said referral management server and said step of providing updates said user invokeable content at second intervals.

14. The method of claim 13 wherein said step of selecting said referral content element determines said first interval, whereby said referral management server determines said first and second intervals and said user invokeable content for updating to said referral content element.

15. A method of controlling the presentation of advertising content on Web pages provided by affiliate Web sites, said method comprising the steps of:
a) distributing an advertisement loader to an affiliate Web sites for incorporation into a predetermined Web page;
b) uploading, by a referral management server system to a client browser, a referral content element in response to a request generated by the evaluation of said advertisement loader by said client browser;
c) executing, by said client browser, said referral content element to
(i) retrieve first predetermined text from said referral management server system;
(ii) write second predetermined text, including said first predetermined text, into said predetermined Web page as provided within said client browser to establish an invokeable advertisement unit within said Web page,
(iii) monitor of user interface actions recognized by said client browser relative to said Web page, said monitoring producing interaction data descriptive of non-invoking user interface actions recognized by the client browser, and invoking data descriptive of an invoking user interface action,
(iv) transfer of said interaction data at intervals, determined independent of user interface actions, to said referral management server system, and
(v) transfer of said invoking data to said referral management server system;
d) selecting, by said referral management server system responsive to said interaction data, said first predetermined text; and
e) evaluating, by said referral management server system, said invoking data to accumulate a count of referrals made with respect to said invokeable advertisement unit.

16. The method of claim 15 wherein said step of uploading identifies to said referral management server system predetermined client browser maintained information including the Web address of said predetermined Web page and wherein said step of uploading includes the step of choosing, by said referral management system, said referral content element responsive to said predetermined client browser maintained information.

17. The method of claim 15 wherein said step of executing iteratively retrieves said first predetermined text and writes said second predetermined text to said predetermined Web page and wherein said step of selecting provides for a respectively iterative identification of invokeable advertisement units as said first predetermined text

18. The method of claim 17 wherein said step of evaluating further evaluates said interaction data to characterize said invoking and non-invoking user interface actions with respect to said invokeable advertisement units.

19. The method of claim 18 wherein said step of evaluating includes the step of categorizing, based on said invoking data and said interaction data, automatic invocations of said invokeable advertisement unit.

20. The method of claim 19 wherein said step of categorizing includes consideration of any of the duration of display of said predetermined Web page by said client browser and the kind and duration of user interface actions over said invoke able advertisement unit.
